(19) United States
(12) Patent Application Publication
(10) Pub. No.: US 2026/0171581 A1
(43) Pub. Date: Jun. 18, 2026

(54) MODULAR CONNECTING SYSTEM

(71) Applicant: Athlinks Inc., Chanhassen, MN (US)

(72) Inventors: John Paul Kelsey, Henderson, KY (US); Raymond Wayne Wheeler, Evansville, IN (US)

(73) Assignee: Athlinks Inc., Chanhassen, MN (US)

(21) Appl. No.: 19/416,908

(22) Filed: Dec. 11, 2025

Related U.S. Application Data
(60) Provisional application No. 63/733,845, filed on Dec. 13, 2024.

(51) Int. Cl. H01M 50/264; F16B 21/02; H01M 50/258

(52) U.S. Cl. CPC H01M 50/264; F16B 21/02; H01M 50/258

(57) ABSTRACT

A modular connecting system including a first connector and a second connector. The first connector includes a main body and a plurality of lobes that extend radially outward from the main body. The second connector is capable of receiving the first connector. The second connector includes a connector opening with a plurality of lobe regions. The connector opening is sized to form a close fit with a perimeter of the first connector such that the first connector may be inserted along a connection axis into the connector opening when the plurality of lobes is aligned with the plurality of lobe regions. The second connector includes a plurality of lobe retention features spaced between neighboring lobe regions. The first connector is rotatable about the connection axis between a free state and a connected state while in a connecting position with the second connector.

### CROSS-REFERENCE TO RELATED APPLICATION(S)

This application claims the benefit of U.S. Provisional Application Ser. No. 63/733,845, filed Dec. 13, 2024, the disclosure of which is hereby incorporated by reference in its entirety.

### BACKGROUND

The demand for more versatile timing systems in sporting events has grown. Current timing solutions often lack the flexibility needed to accommodate various event formats and environments. There is a need for advancements to timing systems that offer enhanced adaptability and ease of use, ensuring reliable performance across a range of sporting events.

### SUMMARY

In general terms, this disclosure is directed to a modular connecting system. In some embodiments, and by non-limiting example, the modular connecting system for a timing system includes a first connector and a second connector. The first connector includes a main body and a plurality of lobes. The plurality of lobes extends radially outward from the main body. The second connector is capable of receiving the first connector. The second connector includes a connector opening with a plurality of lobe regions. The plurality of lobe regions corresponds to the plurality of lobes such that there is one lobe region for each lobe. The connector opening is sized to form a close fit with a perimeter of the first connector such that the first connector may be inserted along a connection axis into the connector opening when the plurality of lobes is aligned with the plurality of lobe regions. The second connector includes a plurality of lobe retention features spaced between neighboring lobe regions. The first and second connectors are in a connecting position when the first connector is positioned within the connector opening of the second connector. The first connector is rotatable about the connection axis between a free state and a connected state while in the connecting position. The first and second connectors are in the free state when the first connector is removeable from the second connector about the connection axis. The first and second connectors are in the connected state when the plurality of lobe retention features overlaps the plurality of lobes.

In some embodiments, and by non-limiting example, a connector for a modular connecting system includes a main body, a plurality of lobes, a plurality of component attachment features, and a plurality of connector attachment features. The main body defines a top surface and a bottom surface. A connection axis is defined centrally extending through the main body between the top and bottom surfaces. The plurality of lobes extends outward from the main body and radially outward from the connection axis. The plurality of lobes includes a primary lobe. The primary lobe is larger than the remaining lobes of the plurality of lobes. The plurality of component attachment features extends through the main body between the top and bottom surfaces. The component attachment features are configured to attach the connector to a component of a timing system. The plurality of connector attachment features extend through a portion of the main body. The connector attachment features are configured to connect the connector to other connectors.

In some embodiments, and by non-limiting example, a connector for a modular connecting system includes a connector opening, a plurality of lobe retainment features, and an outer ring. The connector opening extends through top and bottom surfaces. The connector opening includes a main body region and a plurality of lobe regions. The connector opening is sized to receive a mating connector. The plurality of lobe retainment features partially defines a perimeter of the connector opening. The plurality of lobe retainment features is configured to retain the mating connector. The outer ring defines a portion of the bottom surface. The plurality of lobe retainment features extends radially inward from the outer ring.

In some embodiments, and by non-limiting example, a battery pack for a timing system includes a battery carrier, a plurality of first connectors, and a plurality of battery assemblies. The battery carrier defines a carrier plate, a handle, and a plurality of connector mounting regions on the carrier plate. The plurality of first connectors is attached to the carrier plate at the connector mounting regions. Each of the first connectors includes a main body and a plurality of lobes that extend radially outward from the main body. The plurality of battery assemblies each include a battery mounted to a battery adapter, and a second connector mounted to the battery adapter. The second connector includes a connector opening adapted to receive the plurality of first connectors. The second connector includes a plurality of lobe retention features adapted to retain the lobes of the plurality of first connectors. Each of the plurality of battery assemblies is removably attached to the battery carrier by the plurality of first connectors and the second connector. The plurality of first connectors is securable to the second connector by inserting each of the first connectors into the connector opening and twisting either the first or second connector such that the plurality of lobes is overlapped by the plurality of lobe retention features.

### BRIEF DESCRIPTION OF THE DRAWINGS

FIG. 1 is a first perspective view of an example first connector in accordance with the principles of the present disclosure.

FIG. 2 is a second perspective view of the first connector of FIG. 1.

FIG. 3 is a first perspective view of an example second connector in accordance with the principles of the present disclosure.

FIG. 4 is a second perspective view of the second connector of FIG. 3.

FIG. 5 is an exploded perspective view of an example modular connecting system in accordance with the principles of the present disclosure.

FIG. 6 is a perspective view of the modular connecting system of FIG. 5 when the modular connecting system is in a free state.

FIG. 7 is a perspective view of the modular connecting system of FIG. 5 when the modular connecting system is in a connected/locked state.

FIG. 8 is a perspective view of an example double first connector in accordance with the principles of the present disclosure.

FIG. 9 is a perspective view of an example battery carrier in accordance with the principles of the present disclosure.

FIG. 10 is a first perspective view of an example carrier assembly in accordance with the principles of the present disclosure.

FIG. 11 is a second perspective view of the carrier assembly of FIG. 10.

FIG. 12 is a perspective view of an example battery assembly in accordance with the principles of the present disclosure.

FIG. 13 is a perspective view of an example battery pack in accordance with the principles of the present disclosure.

FIG. 14 is an exploded perspective view of an example reader assembly in accordance with the principles of the present disclosure.

FIG. 15 is a perspective view of the reader assembly of FIG. 14 in an assembled configuration.

FIG. 16 is a first perspective view of another example second connector in accordance with the principles of the present disclosure.

FIG. 17 is a second perspective view of the second connector of FIG. 16.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure relates generally to a modular connecting system that can be used to facilitate various mechanical connections within a timing system. The timing system relates generally to the components needed to time, track progress, and otherwise operate an event, such as a sports race. The components within the timing system include, for example, ground antennas, side antennas, readers, batteries, stands, etc. The modular connecting system may be used to connect any number of different components within the timing system. Only limited examples of the modular connection system are described below, but it should be understood that the modular connecting system can be used with other components, not expressly described.

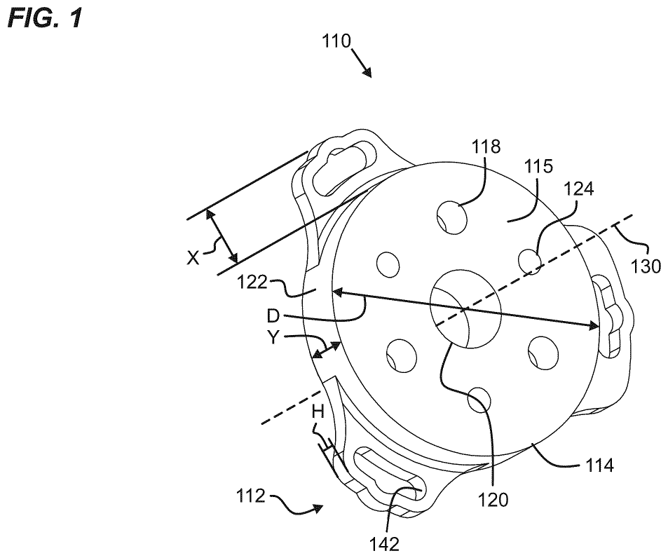

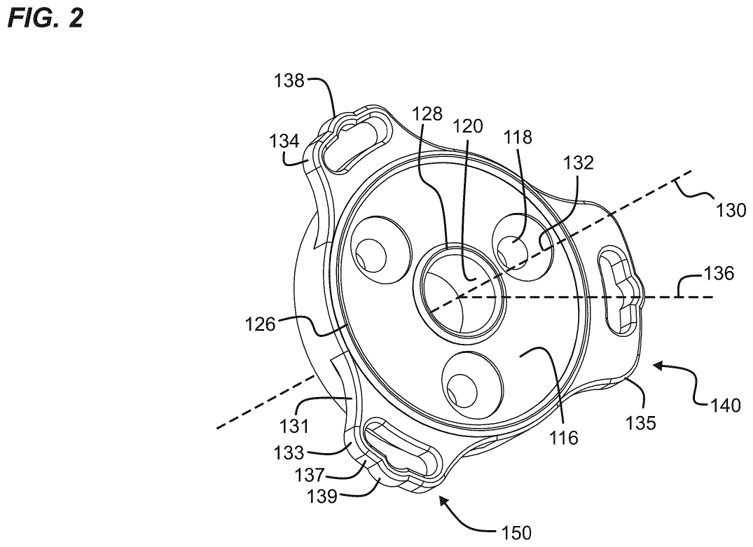

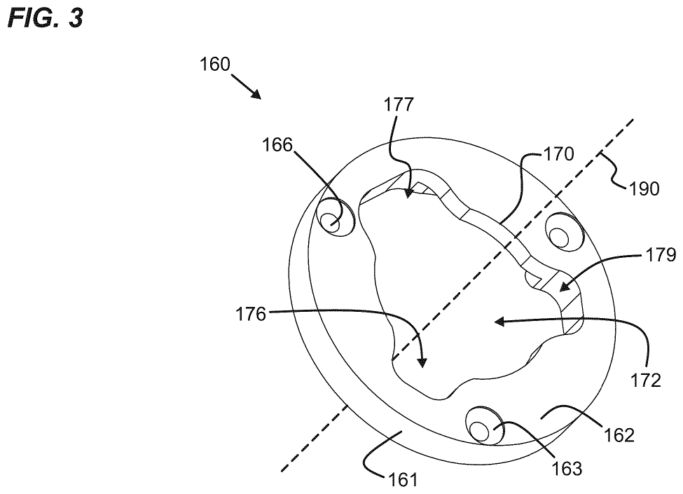

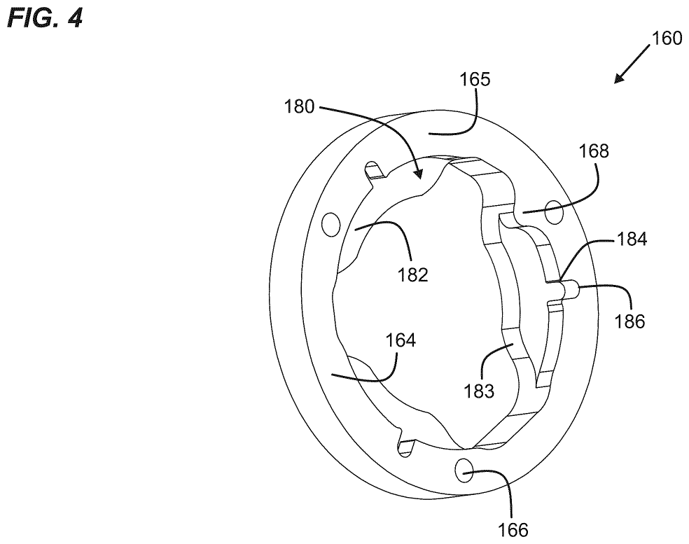

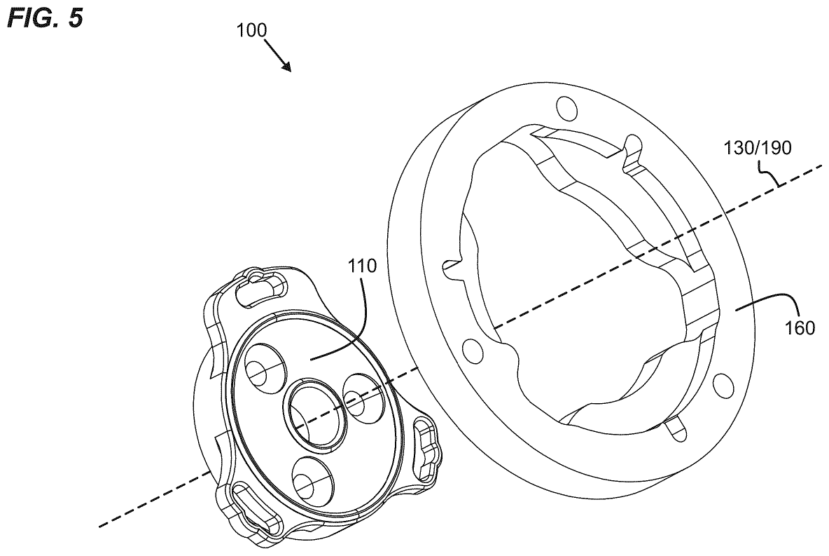

A modular connecting system 100 includes a first connector 110 and a second connector 160. An example first connector 110 is shown in FIGS. 1 and 2 and an example second connector 160 is shown in FIGS. 3 and 4. The first connector 110 can be mated with the second connector 160 to form the modular connecting system 100, as shown in FIGS. 5-7. Various aspects of the connecting system 100 will be discussed below.

In certain examples, the first connector 110 may be referred to as a male connector. The first connector 110 defines a plurality of lobes 112 that engage the second connector 160. In certain examples, the lobes 112 extend radially outward from a main body 114. In certain examples, the main body 114 is puck shaped or disc shaped with circular top and bottom surfaces 115, 116 that are centered about a first connection axis 130 that extends through and normal to the top and bottom surfaces. As shown, the main body 114 includes a central cavity 120 extending between the top and bottom surfaces 115, 116 that is centered about the first connection axis 130.

In certain examples, the main body 114 includes component attachment features 118. The component attachment features 118 enable the first connector 110 to be attached to different pieces of timing equipment, such as battery adapters 84, battery carriers 30, stands, antennas, etc., or to another first connector 110. As shown, the component attachment features 118 may form fastener openings that extend through the top and bottom surfaces 115, 116. In certain examples, the first connector 110 includes three component attachment features 118 that are evenly spaced radially around the first connection axis 130 and between the central cavity 120 and an outer edge 122 of the main body 114.

In certain examples, the first connector 110 also includes a plurality of connector attachment features 124. In certain examples, the connector attachment features 124 form fastener cavities similar to the component attachment features 118. In certain examples, each of the connector attachment features 124 may define an opening on the top surface 115, but the fastener cavities defined by the connector attachment features 124 do not continue all the way through to the bottom surface 116. The connector attachment features 124 are spaced radially around the top surface 115 at the same distance from the first connection axis 130 as the component attachment features 118. In certain examples, the connector attachment features 124 are evenly spaced between neighboring fastener attachment features. In certain examples, either or both of the component attachment features 118 and/or the connector attachment features 124 may be threaded to receive threads of a fastener.

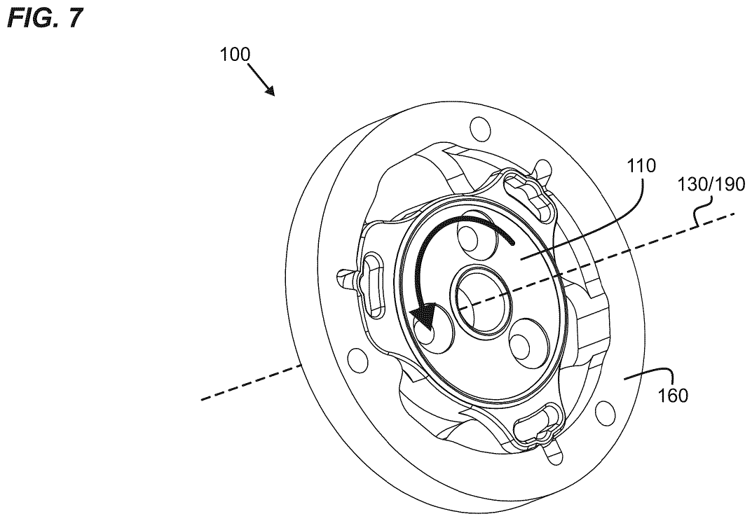

In certain examples, the bottom surface 116 is recessed below a raised perimeter 126 along the outer edge 122. By recessing the bottom surface 116, rotational friction is reduced when the first connector is inserted into the second connector 160 and twisted into a connected or locked state (as shown in FIG. 7). The recessed bottom surface 116 also provides clearance for fasteners that may be used in the component attachment features 118. In certain examples, the bottom surface includes tapered edges 132 around each of the component attachment features 118 to provide additional clearance to seat a fastener head without the fastener head protruding beyond the raised perimeter 126. In certain examples, a perimeter of the central cavity 120 forms an inner raised perimeter 128 that is the same height as the raised perimeter 126.

The plurality of lobes 112 extends from the outer edge 122 and the bottom surface 116. In certain examples, the plurality of lobes 112 may include a primary lobe 140 and multiple secondary lobes 150. In certain examples, each of the plurality of lobes 112 is evenly spaced about the outer edge 122 of the first connector. In certain examples, the primary lobe 140 may be larger than the secondary lobes 150. In certain examples, there are three total lobes 112, with one primary lobe 140 and two secondary lobes 150.

In certain examples, the lobes 112 are symmetric about a lobe centerline 136 defined as a line extending outward from and normal to the first connection axis 130 through a center of each lobe 112. As shown, the center of each lobe 112 is spaced 120 degrees apart when viewed about the first connection axis 130 and as measured between each lobe centerline 136.

In certain examples, the lobes 112 include a curved outer perimeter 134. The curved outer perimeter 134 follows a similar path for the primary lobe 140 as it does for the secondary lobes 150. The curved outer perimeter 134 is mirrored about the lobe centerline 136 because of the symmetry of each lobe 112. In certain examples, each side of the curved outer perimeter 134 includes four distinct sections. A first section 131 begins by extending tangentially out of the outer edge 122 and curves outward away from the first connection axis 130. A second section 133 forms a rounded corner 135 of the lobe. A third section 137 forms a straight portion running roughly parallel to the nearest portion of the outer edge 122. A fourth section 139 forms a portion of a bump 138 with the lobe centerline splitting the bump 138.

Each lobe 112 has a height H and a length X. In certain examples, the height H and length X are the same between the primary lobe 140 and the secondary lobes 150, such that the primary differentiator between the primary lobe 140 and the secondary lobes 150 is a width of the lobes 140, 150. In certain examples, the length X is between 10 and 30 percent of a diameter D of the main body 114. In certain examples, the length X is between 15 and 25 percent of the diameter D of the main body. In certain examples, the height H is between 20 and 50 percent of a main body height Y. In certain examples, the height H is between 35 and 45 percent of the main body height Y.

In certain examples, a lobe cavity 142 is defined through each lobe 112. The lobe cavity 142 enables the bump 138 to flex when the bump 138 contacts the second connector 160 during locking. In certain examples, the lobe cavity 142 has a perimeter that follows the curved outer perimeter 134. In certain examples, the lobe cavity 142 is the same size on the primary lobe 140 as it is on the secondary lobes 150.

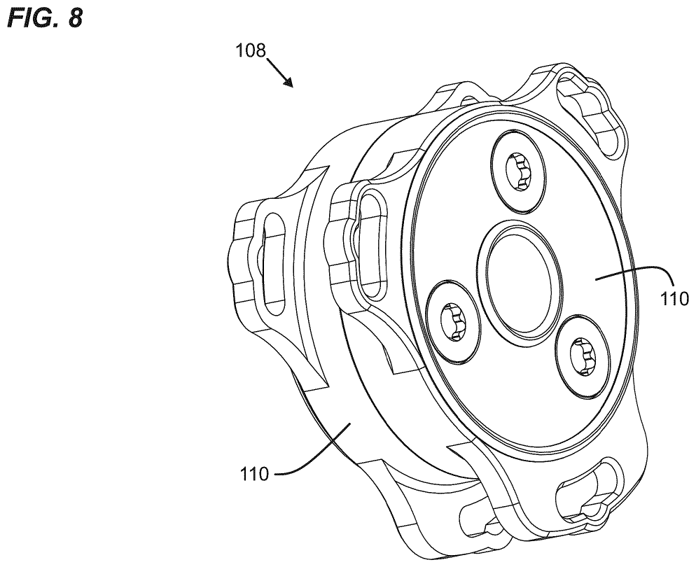

The connector attachment features 124 and fastener attachment features 118 may be used to connect two first connectors 110 together, as shown in FIG. 8. In certain examples, the top surface 115 of one of the first connectors 110 is secured to the top surface 115 of the other of the first connectors 110, as shown in FIG. 7. In certain examples, as shown in FIG. 1, the fastener attachment features 118 and the connector attachment features 124 are spaced equally apart from the lobe centerline 136 in an alternating pattern around the top surface 115 such that when two first connectors 110 are joined together on their top surfaces 115, with the plurality of lobes 112 aligned, the fastener attachment features 118 of one first connector 110 align with the connector attachment features 124 of the other first connector 110. In certain examples, the fastener attachment features 118 of the one of the first connectors 110 are aligned with the connector attachment features 124 of the other of the first connectors 110, such that a fastener may be used to secure the two first connectors 110 together to form a double first connector 108. In this example, the fastener would be inserted through the bottom side of the one of the first connectors 110 at the fastener attachment feature 118 and received at the top side 115 of the other of the first connectors 110 at the opening of the connector attachment feature 124.

FIGS. 3-4 show an example second connector 160. In certain examples, the second connector 160 may be referred to as a female connector designed to receive and retain the first male connector 110. In certain examples, the second connector 160 is puck shaped or disc shaped with circular top and bottom surfaces 162, 164. In certain examples, the second connector 160 includes a connector opening 170 extending through the top surface 162 to receive the first connector 110. A second connection axis 190 is defined extending centrally and normal to the top and bottom surfaces 162, 164. In certain examples, the second connector 160 includes a plurality of lobe retainment features 180 that is designed to retain the lobes 112 of the first connector 110.

In certain examples, the connector opening 170 forms a close fit with a first connector perimeter. In certain examples, the connector opening 170 is centered about the second connection axis 190. In certain examples, the connector opening 170 includes a main body region 172 and a plurality of lobe regions 176 where the main body region 172 is sized to fit the main body 114 of the first connector 110 and the lobe regions are sized to accommodate the lobes 112 of the first connector 110. In certain examples, the plurality of lobe regions 176 includes a primary lobe region 177 and two secondary lobe regions 179 where the primary lobe region is sized to accommodate the primary lobe 140 and the secondary lobe regions 179 are sized to accommodate the secondary lobes 150. In certain examples, the secondary lobe regions 179 are smaller than the primary lobe 140 such that the mating between the first connector 110 and the second connector 160 is keyed, where the first connector can only be inserted when the primary lobe 140 is aligned with the primary lobe region 177.

In certain examples, second connector 160 includes component attachment features 166. The component attachment features 166 enable the second connector 160 to be attached to different pieces of timing equipment, such as the battery adapters 84, battery carriers 30, stands, antennas, etc. As shown, the component attachment features 166 form fastener openings that extend through the top and bottom surfaces 162, 164. In certain examples, the second connector 160 includes three component attachment features 166 that are evenly spaced radially around the second connection axis 190 and between the connector opening 170 and an outer edge 161 of the second connector 160. In certain examples, the top surface 162 includes tapered edges 163 around each of the component attachment features 166 to provide additional clearance to seat a fastener head without the fastener head protruding beyond the top surface 162.

In certain examples, the bottom surface 164 is stepped to define an outer ring 165 and the plurality of lobe retainment features 180. The lobe retainment features 180 are offset from a top of the outer ring 165, closer to the top surface 162, to provide clearance for the plurality of lobes 112. In certain examples, the offset is at least the height H of the lobe 112 plus a height of the raised perimeter 126. In certain examples, the lobe retainment features 180 form ledges 182 projecting radially inward towards the second connection axis 190. In certain examples, the ledges 182 project inward from the outer ring 165 a distance that is about the length X of the lobes 112. The lobe retainment features 180 are positioned between each of the lobe regions 176. The ledges 182 have a profile 183 that partially defines a perimeter of the connector opening 170. The ledges 182 prevent outward movement about the first connection axis when the first and second connectors 110, 160 are in the connected/locked state.

In certain examples, the outer ring 165 defines a stop feature 168 that prevents the first connector 110 from rotating one direction about the first connection axis 130 when the first connector 110 is inserted into the second connector 160. In certain examples, the stop feature 168 prevents counterclockwise rotation of the first connector 110 about the first connection axis 130 when viewing the top surface 115. In certain examples, the stop feature 168 forms a radially inward projection about the second connection axis 190 that creates an interference with one of the lobes 112 when attempting to rotate the first connector 110 the wrong direction. In certain examples, the stop feature 168 interferes with one of the secondary lobes 150 to prevent the first connector from rotating in the undesired direction. In certain examples, the stop feature also prevents over rotation of the first connector when the first connector is twisted in the second connector. In certain examples, the stop feature 168 interferes with the primary lobe 140 to prevent the first connector 110 from over rotating.

In certain examples, the outer ring 165 also defines one or more tactile interference features 184 and one or more relief features 186. In certain examples, there is a tactile interference feature 184 for each lobe 112. In certain examples, the tactile interference feature is designed to interfere with the bump 138 in order to provide slight resistance when twisting the first connector toward, but just before, the connected/locked state. The bump 138 is able to deflect because of the lobe cavity 142. The tactile interference feature 184 may form a small protrusion extending radially inward toward the second connection axis 190 from the outer ring 165. Immediately after the tactile interference feature 184, the relief feature 186 provides clearance for the bump 138. The first connector is in the connected/locked state with the second connector when the bump 138 of each lobe is positioned at the relief features 186 adjacent each of the lobe retainment features 180. A user may feel the change from the tactile interference feature 184 to the relief feature 186 when turning the first connector 110. The bump 138 of the first connector 110 is prevented from rotating past the relief feature 186 because of the stop feature 168.

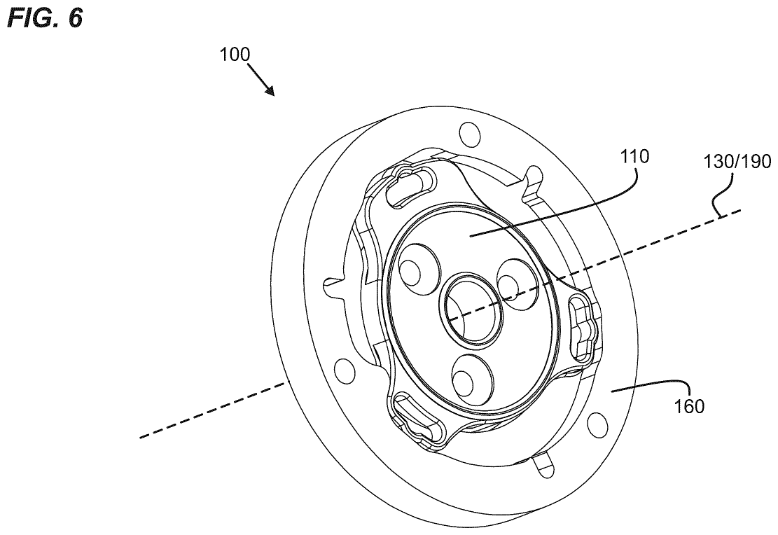

FIGS. 5-7 show an example of how the first and second connectors 110, 160 can be aligned, inserted, and connected. In an actual use case, the first and second connectors 110, 160 would be attached to other components of the timing system such that the first connector 110 could not be inserted past the outer ring 165 or bottom surface 164. FIG. 5 shows the aligning of the first connection axis 130 with the second connection axis 190 which is required for the two connectors to be connected together. FIG. 5 also shows the alignment of the lobes 112 with the lobe regions 176. When the lobes 112 are aligned with the lobe regions 176, and, in certain examples, when the primary lobe 140 is aligned with the primary lobe region 177, the first connector 110 may be inserted into the second connector 160, as shown in FIG. 6. When the first connector 110 is fully inserted into the second connector 160, the modular connecting system 100 is in a connected state. When the first connector 110 is fully inserted into the second connector 160, but not yet rotated, the modular connecting system 100 is in a free state. Finally, either the first or the second connector 110/160 can be rotated approximately 60 degrees about the first and second connection axes 130/190 to achieve the connected state. FIG. 7 shows that when the first and second connectors 110, 160 are in the connected state, the bumps 138 are aligned with the relief features 186 and the stop feature 168 contacts the primary lobe 140. When the first and second connectors 110, 160 are in the connected state, the first connector 110 cannot be removed along the first connection axis 130 without first twisting either the first or second connector 110, 160 in the opposite direction as was done to achieve the connected state.

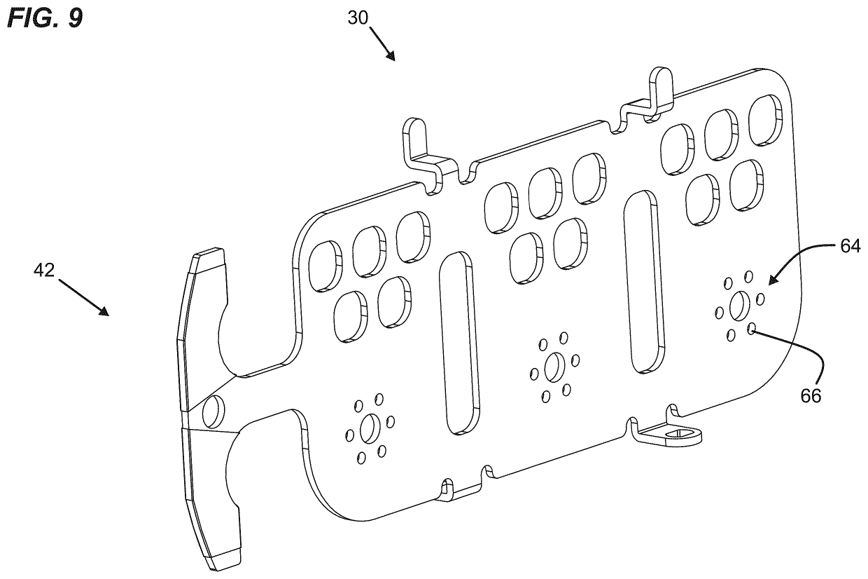

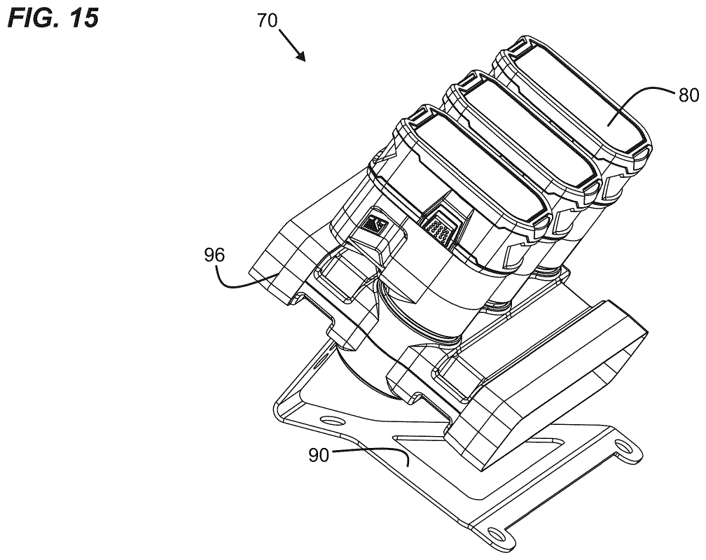

FIGS. 9-15 show various examples of how the modular connecting system 100 can be used. The examples shown are not meant to be exhaustive, a person of ordinary skill in the art would understand how the modular connecting system 100 could be applied to other use cases within and outside of a timing system.

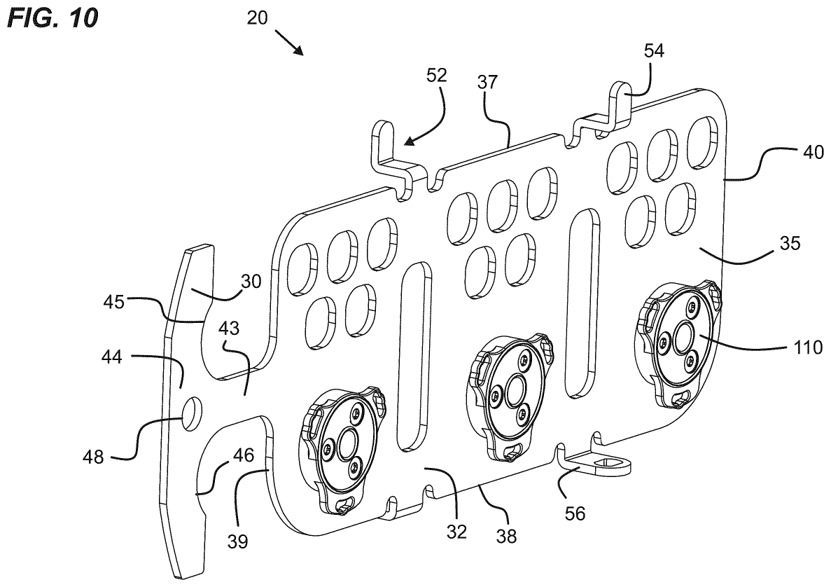

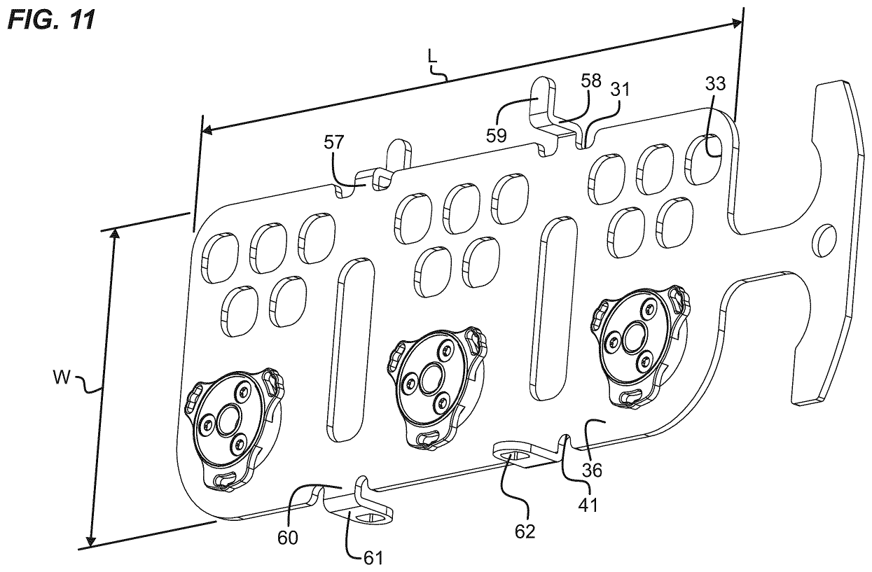

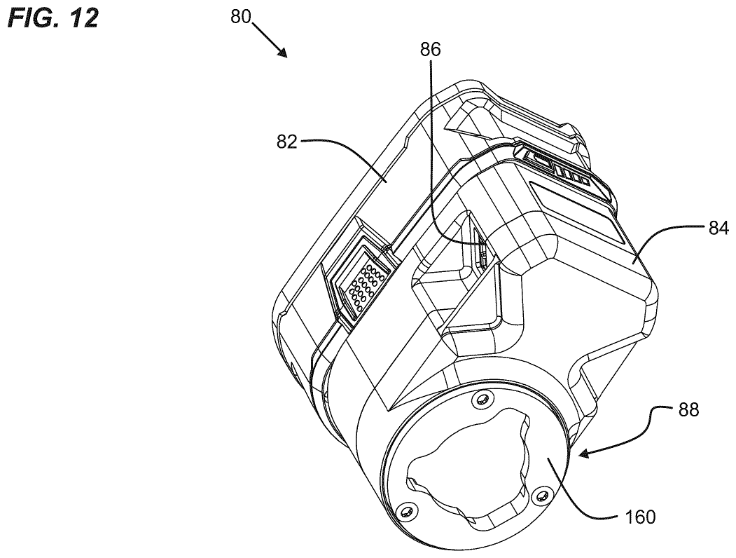

FIG. 9 shows an exemplary battery carrier 30 adapted to be used with the modular connecting system 100 to transport and use battery assemblies 80 (shown in FIG. 12) for powering different aspects of the timing system. FIGS. 10 and 11 show the battery carrier 30 with a plurality of first connectors 110 to form a carrier assembly 20.

The battery carrier 30 defines a carrier plate 32, a handle 42, a number of connector regions 64, and a number of carrier tabs 52. The carrier plate 32 forms a flat surface for mounting connectors, like first or second connectors 110, 160 at the connector regions 64. In certain examples, the carrier plate 32 is a rectangular plate with a first surface 35 and a second surface 36. In certain examples, the carrier plate 32 has a width W that corresponds to a length of a battery assembly 80 and extends between first and second sides 37, 38. In certain examples, the carrier plate 32 has a length L that provides enough room for three battery assemblies 80 to sit side by side with space in between and extends between first and second ends 39, 40. In certain examples, the battery carrier 30 is rigid. In other examples, the battery carrier 30 is flexible.

In certain examples, the connector regions 64 enable the connection of either the first or second connectors 110, 160 to the battery carrier. In certain examples, the connector region 64 includes a plurality of fastener openings 66 to allow fasteners to either attach to, or pass through, the battery carrier 30. In certain examples, the fastener openings are used to facilitate connection to two first connectors 110 where one first connector is positioned on each side of the connector region 64. Like the double first connector 108 described above, two first connectors 110 can be attached to each other with the battery carrier 30 fitting between them. FIGS. 10-11 show first connectors 110 attached to each other and to the battery carrier 30 with fasteners extending through the component attachment features 118, the connector attachment features 124, and the fastener opening 66.

In certain examples, the handle 42 extends from the first end 39 of the carrier plate 32. The handle 42 includes a stem 43, and a grip feature 44. In certain examples, the grip feature 44 includes first and second finger detents 45, 46 where the first finger detent 45 extends outwardly from the stem toward the first side 37, and the second finger detent 46 extends oppositely away from the stem toward the second side 38. In certain examples, the stem 43, or other parts of the handle 42, are designed to accommodate loops of cables extending from the battery assemblies 80 or from another part of the timing system. In certain examples, as discussed below, the battery carriers 30 can be stacked. In certain examples, when the battery carriers 30 are stacked, cable can be wrapped around an outside of a group of neighboring handles 42. In certain examples, the handle 42 also includes a mounting hole 48. The mounting hole 48 may be used to hang battery packs 10 from a stand or other device.

In certain examples, carrier tabs 52 extend from the first and/or second side 37, 38 of the battery carrier 30. The carrier tabs 52 are designed to stack or join multiple battery carriers 30 together. In certain examples, the carrier tabs 52 include first carrier tabs 54 and second carrier tabs 56 where the first carrier tabs 54 engage with the second carrier tabs 56 of a second battery carrier 30 to join the two battery carriers 30 together.

In certain examples, the first carrier tabs 54 have a stepped tab design. The first carrier tabs 54 have a first upward portion 57 followed by an outward portion 58, which is followed by a second upward portion 59 to create the stepped design. The first upward portion 57 extends from a recessed portion 31 of the first side 37, in line with the carrier plate 32. The outward portion 58 extends outward from an end of the first upward portion 57 and normal to the first and second surfaces 35, 36. The second upward portion 59 extends from an outward end of the outward portion 58. In certain examples, the first side 37 includes two first carrier tabs 54 that are positioned in gaps between neighboring first connectors 110. In certain examples, the two first carrier tabs 54 have outward portions that extend oppositely, such that one of the first carrier tabs has an outward portion 59 that extends normally outward from the first surface 35, and the other first carrier tab 34 has an outward portion 58 that extends normally outward from the second surface 36.

In certain examples, the second side 38 includes the same number of second carrier tabs 56 as the first side 37 includes first carrier tabs 54. In certain examples, the second side 38 has two second carrier tabs. In certain examples, the second carrier tabs 56 have an L-shaped design. The second carrier tabs 56 have an upward portion 60 followed by an outward portion 61. The upward portion 60 extends from a recessed portion 41 of the second side 38. The outward portion 61 extends from an end of the upward portion 60 and normal to the first and second surfaces 35, 36. The outward portion 61 includes a tab opening 62. The second carrier tabs 56 are wider than the first carrier tabs 54 such that the tab opening 62 is able to fit the second upward portion 59 when two battery carriers 30 are joined together.

In certain examples, the battery carriers 30 include a plurality of pass-through openings 33 that extend between the first and second surfaces 35, 36. The pass-through openings may be used to reduce weight. The pass-through openings 33 may also be used to run cables, straps, or other components of the timing system through the battery carrier 30. For example, cables may run through the pass-through openings 33 to connect battery assemblies 80 on one side of the battery carrier 30 with battery assemblies 80 on the other side of the battery carrier 30.

An example battery assembly 80 is shown on FIG. 12. In certain examples, the battery assembly 80 includes a battery 82, a battery adapter 84, and a connector mounting region 88. In certain examples, the battery 82 is an off-the-shelf rechargeable battery. For example, the battery 82 may be a rechargeable battery commonly used for portable power tools. The battery adapter 84 provides a housing for the battery 82. The battery adapter 84 also includes a port 86 for delivering power from the battery to various components of the timing system. In certain examples, the port 86 is an ethernet port, and the battery adapter 84 enables Power over Ethernet (POE) technology to transfer power from the battery 82. In certain examples, the battery adapter 84 provides a mounting surface at the mounting region 88 for mounting either the first or second connector 110, 160. In certain examples, the mounting region 88 includes fastener mounting locations that align with the component attachment features 118 or the component attachment features 166.

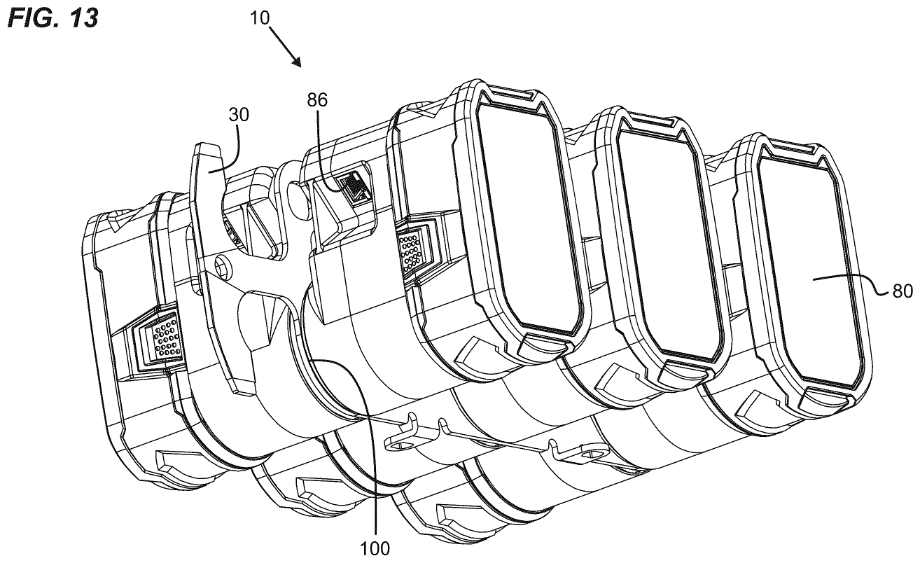

FIG. 13 shows a battery pack 10 which includes the carrier assembly 20 with a number of battery assemblies 80 attached to the battery carrier 30 using the modular connecting system 100. In the example shown, the battery pack 10 includes six batteries 82. Each of the six batteries is attached by one modular connecting system 100 where the first connector 110 is secured to the battery carrier 30 and the second connector 160 is secured to the battery adapter 84. The battery pack 10 can be used to provide power for varying devices and systems. The battery assemblies 80 can be linked in parallel or series using the ports 86 to string the battery assemblies together or link them to a central system. Multiple battery packs 10 can be connected together using the carrier tabs 52 to provide as much power as would be needed for multi-hour, or even multi-day events, like ultramarathons.

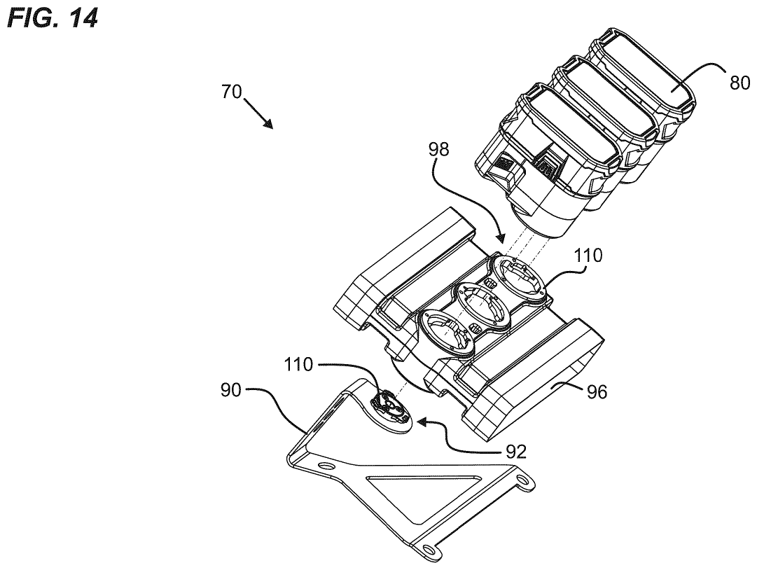

Another example use of the modular connecting system 100 is shown in FIG. 14 with a reader assembly 70. In the example shown, the reader assembly 70 includes a stand 90, a reader 96, and a plurality of battery assemblies 80 attached together. The stand 90 includes a connector mounting region 92, where a first or second connector 110, 160 can be attached. As shown, a first connector 110 is attached to the stand 90 so that the stand can accept various different components of a timing system, like the reader 96. In certain examples, the reader 96 is an ultra high frequency radio frequency identification (UHF RFID) reader as is commonly used for tracking participants in a sporting event like a running race. As shown, the reader 96 includes a connector mounting region 98 where a first or second connector 110, 160 can be attached. As shown, a second connector 160 is mounted to the underside (not visible) of the reader and three first connectors 110 are mounted to the top side of the reader. The second connector 160 on the underside connects to the first connector 110 on the stand 90. The first connectors 110 on the top side connect to second connectors 160 on the battery assemblies 80. Attaching the battery assemblies 80 directly to the reader 96 enables simplified power supply to the reader 96.

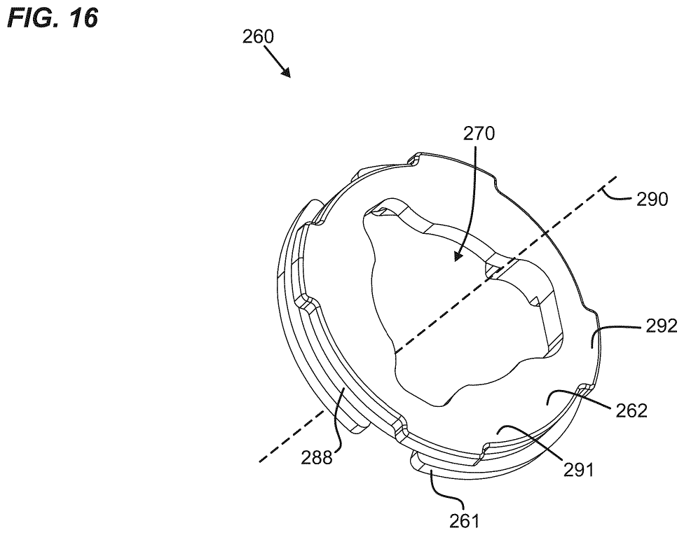

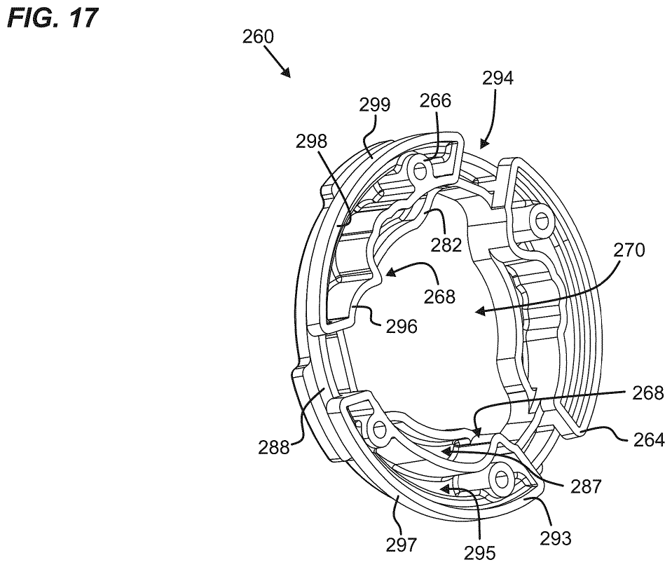

Another example second connector 260 is shown on FIGS. 16 and 17. The second connector 260 shares many of the same features as the second connector 160. For conciseness, only certain different aspects of the second connector 260 are described. It should be appreciated that the second connector 260 can be part of the modular connecting system 100, used with the first connector 110, and used with the various example components described above.

In certain examples, portions of the second connector 260 are designed to be injection molded. In certain examples, the second connector 260 includes consistent wall thicknesses throughout at least a majority of the connector. In certain examples, the second connector 260 is designed to include additional engagement features for versatility in use. In certain examples, the second connector 260 is designed to include water management features that prevent water buildup within, or around, the connector.

In certain examples, the second connector 260 includes an outer channel 288. In certain examples, the outer channel 288 extends about an outer edge 261. In certain examples, the outer channel 288 is positioned between a top surface 262 and a bottom surface 264. A second connection axis 290 is defined extending centrally through the second connector 260 between the top surface 262 and the bottom surface 264. In certain examples, the outer channel 288 is spaced evenly between the top surface 262 and the bottom surface 264. In certain examples, the outer channel 288 is centered between the top surface 262 and the bottom surface 264. In certain examples, sides of the channel are defined by a plurality of front tabs 292 and a plurality of rear tabs 298. In certain examples, the outer channel 288 provides a side securement region for engaging with corresponding features (not shown) on components such as battery carriers, battery packs, stands etc.

In certain examples, the plurality of front tabs 292 extend radially outward from a circular portion 291 of the top surface 262. In certain examples, an edge of the circular portion 291 is flush with the outer channel 288. In certain examples, the top surface 262 defines a top side of the front tabs 292. In certain examples, a bottom side of the front tabs 292 defines one side of the outer channel 288. In certain examples, the plurality of front tabs 292 is evenly spaced about the outer edge 261. In certain examples, the second connector 260 includes four front tabs 292. In certain examples, the plurality of front tabs 292 may be used for removable attachment to corresponding features (not shown) on components such as battery carriers, battery packs, stands, etc. In certain examples, the front tabs 292 may be twisted into a connected or locked state with a corresponding component, similar to the interaction between the first connector 110 and either of the second connectors 160, 260.

In certain examples, the second connector 260 includes a plurality of drainage channels 294. In certain examples, the plurality of drainage channels 294 is designed to enable water to flow away from the second connector 260. In certain examples, the plurality of drainage channels 294 extends into the bottom surface 264 between a connector opening 270 and the outer edge 261. In certain examples, the plurality of drainage channels is evenly spaced about the outer edge 261. In certain examples, the plurality of drainage channels 294 includes three drainage channels 294.

In certain examples, the plurality of drainage channels 294 splits the bottom surface 264 into a plurality of rear tabs 298. In certain examples, a top side of the rear tabs 298 defines another side of the outer channel 288. In certain examples, the rear tabs 298 include a major rear tab 297 and two minor rear tabs 299. In certain examples, the major rear tab 297 interfaces with the primary lobe 140. In certain examples, the minor rear tabs 299 interface with the secondary lobes 150. In certain examples, the bottom surface 264 defines a contact region 293 of each rear tab 298. In certain examples, the contact region 293 contacts a connected component, such as the battery adapter 84, the reader 96, etc. In certain examples, each rear tab 298 includes at least one component attachment feature 266 that extends through the rear tab 298. In certain examples, there are three rear tabs 298. In certain examples, each rear tab includes a stop feature 268 for limiting rotation of the first connector 110.

In certain examples, each rear tab 298 includes a major cavity 295 that extends into the second connector 260 from the bottom surface 264 towards the top surface 262. In certain examples, the major cavity 295 defines a wall thickness 296 that is constant, or near constant around the major cavity 295. In certain examples, the second connector 260 is hollowed out from the bottom surface 264 such that various portions of the second connector 260 have the wall thickness 296. In certain examples, the second connector includes ledges 282 that retain the first connector 110 when in the connected state. In certain examples, the ledges 282 include ledge cavities 287. In certain examples, the ledge cavities 287 are sized such that the ledges 282 have the wall thickness 296. In certain examples, a constant, or nearly constant wall thickness enables improved processability. In certain examples, the wall thickness 296 facilitates the use of injection molding for manufacturing the second connector 260.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A modular connecting system comprising:
a first connector including a main body and a plurality of lobes extending radially outward from the main body; and
a second connector capable of receiving the first connector, the second connector including a connector opening with a plurality of lobe regions, the plurality of lobe regions corresponding to the plurality of lobes such that there is one lobe region for each lobe, the connector opening being sized to form a close fit with a perimeter of the first connector such that the first connector may be inserted along a connection axis into the connector opening when each of the plurality of lobes is aligned with each of the plurality of lobe regions, the second connector including a plurality of lobe retention features spaced between neighboring lobe regions;
wherein, the first and second connectors are in a connecting position when the first connector is positioned within the connector opening of the second connector, the first connector rotatable about the connection axis between a free state and a connected state while in the connecting position, the first and second connectors being in the free state when the first connector is removable from the second connector about the connection axis, the first and second connectors being in the connected state when the plurality of lobe retention features overlap the plurality of lobes.

2. The modular connecting system of claim 1, wherein the main body defines a plurality of component attachment features for attaching the first connector to a component.

3. The modular connecting system of claim 1, wherein the plurality of lobes includes a primary lobe and two secondary lobes, wherein the primary lobe is larger than the secondary lobes.

4. The modular connecting system of claim 3, wherein the plurality of lobe regions includes a primary lobe region and two secondary lobe regions, wherein the primary lobe region is sized to receive the primary lobe, wherein the secondary lobe regions are sized to receive the secondary lobes, and wherein the secondary lobe regions are smaller than the primary lobe.

5. The modular connecting system of claim 1, wherein the first connector is rotatable 60 degrees about the connection axis between the free state and the connected state.

6. The modular connecting system of claim 1, wherein the first connector is unidirectionally rotatable about the connection axis in a first direction from the free state to the connected state, wherein a stop feature of the second connector prevents rotation about the connection axis in a second direction, opposite the first direction, when the first connector is in the free state.

7. The modular connecting system of claim 6, wherein the stop feature prevents over rotation past the connected state in the first direction.

8. The modular connecting system of claim 1, wherein the second connector defines a plurality of component attachment features for attaching the second connector to a component.

9. The modular connecting system of claim 1, wherein each of the plurality of lobes includes a bump feature at an apex of the lobe.

10. The modular connecting system of claim 9, wherein each of the plurality of lobes includes a lobe cavity, wherein the lobe cavity enables elastic deformation of the bump feature.

11. The modular connecting system of claim 10, wherein the second connector includes a tactile interference feature adjacent to each lobe retention feature, wherein the tactile interference feature contacts the bump feature during a transition between the free state and the connected state.

12. The modular connecting system of claim 9, wherein the second connector includes a relief feature adjacent each of the lobe retention features, wherein when the modular connecting system is in the connected state, the bump feature of the first connector is aligned with the relief feature of the second connector.

13. A connector for a modular connecting system comprising:
a main body defining a top surface and a bottom surface, and a connection axis centrally extending through the main body between the top and bottom surfaces;
a plurality of lobes extending outward from the main body and radially outward from the connection axis, the plurality of lobes including a primary lobe, the primary lobe being larger than the remaining lobes of the plurality of lobes;
a plurality of component attachment features extending through the main body between the top and bottom surfaces, the component attachment features configured to attach the connector to a component; and
a plurality of connector attachment features extending through a portion of the main body, the connector attachment features configured to connect the connector to other similar connectors.

14. The connector of claim 13, wherein each of the plurality of lobes includes a bump feature defining an apex of each of the plurality of lobes.

15. The connector of claim 14, wherein each of the plurality of lobes includes a lobe cavity extending through each of the plurality of lobes.

16. The connector of claim 15, wherein the lobe cavity enables elastic deflection of the bump feature.

17. The connector of claim 13, wherein the main body includes a raised perimeter on the bottom surface, wherein the raised perimeter is designed to reduce contact friction with mating connectors or other components.

18. A connector for a modular connecting system comprising:
a connector opening extending through top and bottom surfaces, the connector opening including a main body region and a plurality of lobe regions, the connector opening being sized to receive a mating connector;
a plurality of lobe retainment features partially defining a perimeter of the connector opening, the plurality of lobe retainment features configured to retain the mating connector; and
an outer ring defining a portion of the bottom surface, the plurality of lobe retainment features extending radially inward from the outer ring.

19. The connector of claim 18, wherein the plurality of lobe regions includes a primary lobe region and two secondary lobe regions, wherein the primary lobe region is larger than the secondary lobe regions.

20. The connector of claim 18, wherein the connector includes a plurality of tactile interference features, wherein the plurality of tactile interference features extends radially inward from the outer ring, wherein one tactile interference feature is adjacent to each of the plurality of lobe retainment features.

21. The connector of claim 20, wherein the connector includes a plurality of relief features, wherein one of the plurality of relief features is adjacent each of the plurality of tactile interference features.

22. The connector of claim 18, wherein the connector includes a stop feature, wherein the stop feature extends radially inward from the outer ring on the bottom surface.

23. The connector of claim 18, wherein the connector includes a plurality of drainage channels at the bottom surface.

24. The connector of claim 18, wherein the connector includes an outer channel about an outer edge of the connector, wherein the outer channel is positioned between the top surface and the bottom surface.

25. The connector of claim 18, wherein the connector defines a plurality of front tabs extending radially outward from a circular portion of the top surface.

26. The connector of claim 18, wherein a majority of the connector has a uniform wall thickness.
